(19) United States
(12) Patent Application Publication
(10) Pub. No.: US 2007/0011026 A1
(43) Pub. Date: Jan. 11, 2007

(54) Interactive user interface for accessing health and financial data

(75) Inventors: Rose Higgins, Washington Crossing, PA (US); Jeremy Nobel, Brookline, MA (US); Deryk Van Brunt, Ross, CA (US)

Correspondence Address: BEYER WEAVER & THOMAS, LLP, P.O. BOX 70250, OAKLAND, CA, 94612-0250, US

(73) Assignee: iMetrikus, Inc., Carlsbad, CA (US)

(21) Appl. No.: 11/432,658

(22) Filed: May 11, 2006

Related U.S. Application Data
(60) Provisional application No. 60/679,893, filed on May 11, 2005.

(51) Int. Cl. G06F 17/00; G06Q 10/00

(52) U.S. Cl. 705/2; 715/741

(57) ABSTRACT

A user interface that integrates and uniformly presents to a healthcare consumer all or most of the consumer's health, health-related, and financial data is described. The interactive user interface is comprised of multiple dashboards which all have a generally uniform appearance and contain one category of health or financial data. A user can configure the size of each dashboard and its placement on the screen. By doing so, a healthcare consumer can view in one screen display data from multiple sources all relating to healthcare. The user interface is presented to a user by a service provider as the interface or window into a healthcare data management system provided by the service provider. The service provider itself stores and manages some of the consumer's health data, such as biometric readings. A dashboard of the present invention can contain data from the service provider or can contain data from an external source, such as an insurance company, a hospital, or a financial services company. In both cases the data are presented in the dashboards in a uniform manner. A consumer can open or “click on” the data in a dashboard and get further detail on the data. In the case of an external source or Web site providing the data, the consumer is taken to the site. The consumer only authenticates herself once when signing on to the service provider's system to view the user interface and dashboards. The consumer does not have to re-authenticate or sign on again when going to an external site via a dashboard.

### CROSS-REFERENCE TO RELATED APPLICATIONS

This application claims priority of U.S. Provisional Application 60/679,893, filed May 11, 2005, entitled “Dashboard for Medical Data Management” which is incorporated by reference.

### FIELD OF THE INVENTION

The present invention relates generally to computer software for delivering and displaying health and health-related financial data. More specifically, the invention relates to interactive user interfaces that facilitate users viewing, integrating, consolidating, and correlating health and financial data.

### BACKGROUND OF THE INVENTION

As the healthcare industry moves towards consumer-directed insurance plans, the burden of managing healthcare costs is increasingly falling on the healthcare consumer. Presently, a consumer must go to several different sources to get all the information needed to make well-informed healthcare decisions with respect to actual health issues such as chronic disease treatment but also with respect to allocating and spending financial resources. Although there are Web sites, call centers, information delivered through mailings, and so on, the information from these sources is not integrated. A healthcare consumer has to collect all the information from numerous sources, which may include insurance companies, financial services companies, hospitals, pharmacies, clinics, doctors' offices, HMOs, PPOs, employers (e.g., information on paycheck stubs), and so on. The list is daunting and few consumers posses the management, organizational, financial, or computer skills needed to efficiently process and utilize all the healthcare and financial information available today to make intelligent decisions with respect to healthcare treatment and prevention, as well as related healthcare finances and spending.

Although all the sources or entities mentioned above may have its own call center or Web site, consumers still need to make further inquiries to get to the information that is relevant to their decision-making process. Most Web sites are text-based, single applications and require that the user “drill down” to get their information. And when they got to the information, the data are typically not rich and not integrated with other healthcare information relevant to the user.

Another issue with having to go to multiple Web sites to get information is having to sign on to each Web site and be authenticated. This requires that the consumer remember login names and passwords. Another issue that arises that makes it difficult for users to assimilate and process the multitude of healthcare information provided to them is the lack of uniformity in how the data are presented to them. The appearance, format, and presentation of the data at the various Web sites and in printed literature, statements, and so on differ significantly from source to source adding complexity to the healthcare consumer's decision-making process.

Consumers today typically have to manage several accounts related to healthcare. For healthy consumers the number can be as high as 10 to 15 financial and health-related accounts. For those with chronic illnesses and who have a compelling need to manage their healthcare and finances, the number can be much higher, yet this segment of the population may be least able to manage and assimilate data available to them for all the reasons described above. Healthcare consumers in general, and particularly those who are under Consumer-Directed Health Plans (CDHP), healthcare plans that consumers obtain themselves rather than through an employer (expected to grow from 3% in 2006 to 12% in 2008 and 24% in 2010) presently find it increasingly difficult to correlate their health data (such as prescription data, biometric readings, etc.) with their financial data (such as co-pays, out-of-pocket expenses, health savings account balances, etc.).

Therefore, it would be desirable to have a user interface intended for use by a healthcare consumer that provides a comprehensive, integrated view of healthcare and financial content and that organizes and displays healthcare-related data in a uniform manner. It would also be desirable to have the same screen display facilitate correlation of all categories of health-related data with a consumer's financial data. Finally, it would also be desirable to have the consumer authenticate (e.g., sign on or logon) herself not more than once to enable access to all or most of their health, healthcare-related, and financial data.

### SUMMARY OF THE INVENTION

A user interface that integrates and uniformly presents to a healthcare consumer all or most of the consumer's health, health-related, and financial data is described. An interactive user interface is comprised of multiple dashboards which all have a generally uniform appearance and contain a specific category or type of health or financial data. A user can configure the size of each dashboard and its placement in the display. By doing so, a healthcare consumer can view in one screen display data from multiple sources all relating in respect to healthcare. The user interface is presented to a user by a service provider as the interface or view into a healthcare data management system provided by the service provider. The service provider may store and manages some of the consumer's health data, such as biometric readings. A dashboard of the present invention can contain data from the service provider or data from an external source, such as an insurance company, a hospital, or a financial services company. In both cases the data are presented in the dashboards in a uniform manner. A consumer can open or “click on” the data in a dashboard and get further detail on the data. In the case of an external source, the consumer is taken to an external Web site. The consumer authenticates herself once when signing on to the service provider's healthcare data management system to view the user interface and dashboards. The consumer does not have to re-authenticate or sign on again when going to an external site via a dashboard.

### BRIEF DESCRIPTION OF THE DRAWINGS

The invention will be better understood by reference to the following description taken in conjunction with the accompanying drawings in which:

FIG. 1 is a network diagram showing the relationship among the entities and components of the healthcare data management system and the user interface of the present invention;

FIG. 2 is a diagram showing a mock configuration of a user interface in accordance in one embodiment of the present invention;

FIG. 3 is a diagram illustrating the ability of a healthcare consumer to go to an external source to get further detail on data displayed in a dashboard in accordance with one embodiment of the present invention; and

FIGS. 4A and 4B are diagrams illustrating the underlying software and network application components for implementing the user interface and dashboards of the present invention.

### DETAILED DESCRIPTION

Reference will now be made in detail to a preferred embodiment of the invention. An example of the preferred embodiment is illustrated in the accompanying drawings. While the invention will be described in conjunction with a preferred embodiment, it will be understood that it is not intended to limit the invention to one preferred embodiment. To the contrary, it is intended to cover alternatives, modifications, and equivalents as may be included within the spirit and scope of the invention as defined by the appended claims.

Methods and systems for enabling a user to view and modify biometric, health-related, and financial data at one central display are described in the various figures. The present invention is a system and method of providing healthcare data to a healthcare consumer. The consumer has a first experience at sign on of being able to view multiple dashboards in a screen display, wherein each dashboard contains one type or category of healthcare data. The user interface provides all relevant healthcare information via uniform dashboards which can be configured and arranged by the user. The user interface is the screen display of a healthcare data management system operated by a healthcare data service provider. Some of the dashboards in the user interface will typically display health data from the service provider. Other dashboards may display data from external entities. However, data from external entities are displayed in dashboards in a format and have an appearance that is similar to each other and to the data displayed from the healthcare data management service provider operating the system.

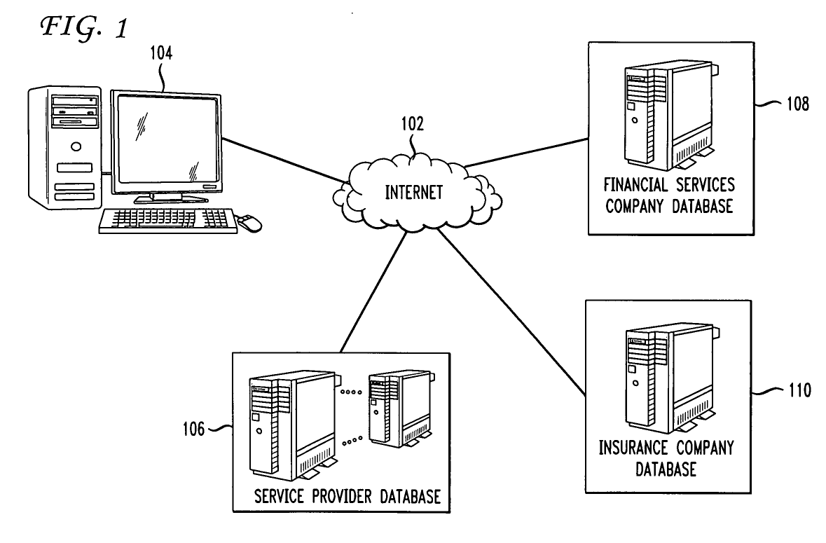

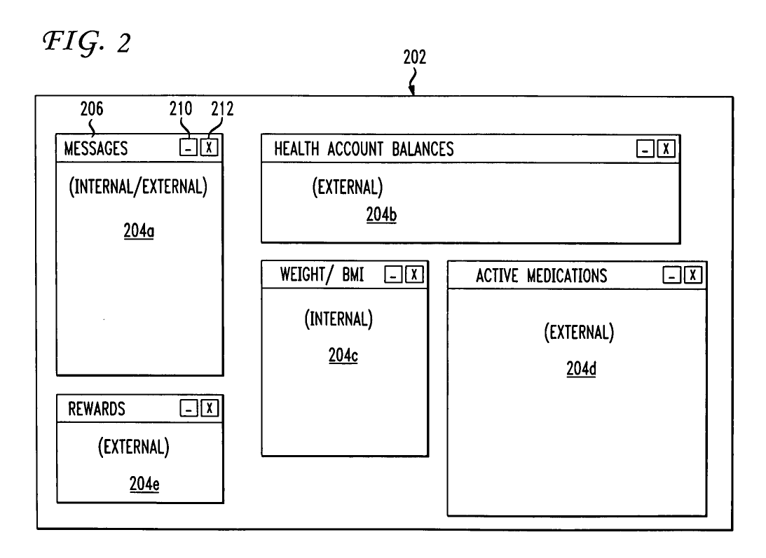

FIG. 1 is a network diagram showing the relationship among the entities and components of the healthcare data management system and the user interface of the present invention. A healthcare consumer (not shown) accesses the Internet 102 via a PC 104 or other IP-enabled device. PC 104 displays data via a user interface (described in FIG. 2 below) from a healthcare data management service provider's database server 106. PC 104 also displays data from external sources, such as financial company database server 108 and insurance company database server 110. These external sources are business partners with the healthcare data management service provider for the benefit of the service provider's customers. In one embodiment, these customers are patients with chronic health issues, such as diabetes, asthma, and heart disease. In a preferred embodiment, because of the business partnerships, data from external sources 108 and 110 are fed directly to PC 104 and do not need to pass through database server 106. In other embodiments, the data from external sources can pass through database server 106 or another component under control of the service provider.

FIG. 2 is a diagram showing a mock configuration of a user interface in accordance in one embodiment of the present invention. A screen display 202 is viewed by a healthcare consumer on PC 104 or other IP-enabled device. Display 202 is comprised of multiple dashboards 204a-e. In the example shown in display 202, dashboards 204a-e are arranged in a random configuration. In other embodiments, the dashboards can be arranged as desired by the consumer. The sizes and shapes of dashboards can differ and are based on user preferences and the level of importance a user gives to the information contained in a dashboard. However, in all cases each dashboard has a similar appearance and format. Using dashboard 204a to illustrate, each dashboard has a border 206, a title 208 and a small option box 210 to minimize and a box 212 to close the dashboard. Border 206 around each dashboard is unadorned and uniform (e.g., a line having the same thickness all around). The font and size of the lettering for title 208 is the same for all dashboards. These basic characteristics of the dashboards give the user interface of the present invention a uniform look and feel and thus provide a psychological or perceived advantage to the consumer when having to analyze, process, compare, correlate, and assimilate the data in all the dashboards to make healthcare and healthcare-related financial decisions. In other embodiments, other user interface features can be implemented, such as options to re-size dashboards, change border characteristics, and other GUI-type attributes.

The source of each dashboard in FIG. 2 is also indicated to illustrate that data can come from an internal source, namely the healthcare data management service provider, such as iMetrikus, Inc. of Carlsbad, Calif., or from external sources. In another embodiment, all the data can come from an internal source or all can come from external sources. In yet other embodiments, display 202 can contain a single dashboard and a dashboard can contain a hybrid of internal and external data. Display 202 can also have subject tabs (not shown) that allow consumers to change the display to show dashboards relevant to another healthcare category, such as another chronic condition or the consumer may want to place all dashboards relating to finances in one screen display under a tab labeled “FINANCES”. Whether there is one display (and thus no tabs) or numerous displays with tabs at the top of the display labeling each category, the concept of the user interface containing dashboards remains the same.

A dashboard that displays information from the service provider database 106 has a secure internal data feed. In the described embodiment, service provider database 106 has a personal health record associated with a consumer that contains a wide variety of healthcare information ranging from biometric readings from home monitoring devices, diet and exercise regimen information, messages, drug prescription data, and so on. In other embodiments the service provider may maintain and provide only one specific type of information such as biometric readings pertaining to one chronic illness or only insurance claim information. The type of information provided by the service provider does not limit in any manner the concept of the user interface and dashboards of the present invention.

A dashboard can also contain data from external sources, such as insurance companies, hospitals, and financial services companies. The data from these external sources enable the user interface to provide a comprehensive view of the consumer's healthcare data. The consumer also decides which dashboards are larger or more prominent on the screen and which ones are smaller based on level of importance of the information contained in the dashboard. As mentioned above, for dashboards that have external sources of data, a consumer can open or click on the data in the dashboard which serve as a hyperlink to a Web site of an external source and allow the consumer to securely migrate from a dashboard to an external Web site.

A dashboard can contain numerous types of data. The most common type is simple text. However with health and financial data, it is expected that there will also be various formats including graphs, charts, tables and other graphical representations of data. A dashboard can also display video and audio data or any type of multimedia data that can be transmitted from an external source.

There is a wide range of types or categories of health and financial data that can be displayed in a dashboard. Some examples of health data include: biometric readings, health risk assessments, diet and exercise data, mental health data, data relating to home inventory/management of medical supplies, lab and test results, and data relating to medications and instructions on medication use. Some examples of financial data include: health savings account data, insurance claims data, healthcare spending data relating to taxes, co-payments, balances due, and charges for health-related services. In addition, dashboards can be configured to trigger alerts, set thresholds, send and receive messages, manage rewards (discussed in further detail below), and so on. They can also be used to configure various types of reports, data regarding adherence to supply and medication usage patterns, statistic reports, and summary reports.

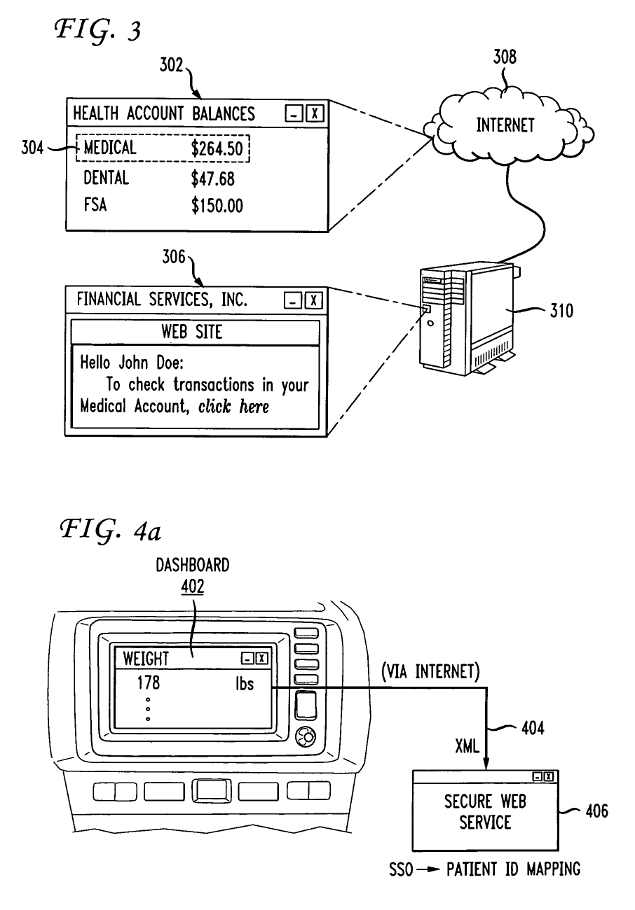

FIG. 3 is a diagram illustrating the ability of a healthcare consumer to go to an external source to get further detail on data displayed in a dashboard in accordance with one embodiment of the present invention. A dashboard 302 is titled “Health Account Balances.” The information displayed is securely transmit from a financial services company and is supplied to the dashboard using methods described below and that known in the art. A consumer clicks on an entry 304 “Medical . . . $264.50” and is migrated via Internet 308 and financial company Web server 310 to the financial company's Web site 306 and is no longer at the service provider's Web site. At the financial company's Web site 306 the consumer can obtain further information on the health savings account without having to sign on to the Web site. Authentication procedures performed at the service provider's Web site allows the consumer to access the financial company's Web site without having to sign on by entering a user name, password, and so on. This is done using methods for single sign on known in the field of Internet application programming. Single sign on provides the user with a seamless transfer from the dashboard to the external Web site where the consumer can obtain detailed information as needed, for example, to inquire as to why an account has a certain balance or how much time a consumer has to deplete a balance.

The amount of data displayed in the dashboard from the external party can also vary based on the needs of the consumer. More detailed information as to a certain balance can be displayed in the dashboard if desired. Constraints on how much data are shown in the dashboards are limited by a previous arrangement between the service provider and the external source, such as the financial services company. By virtue of the user interface dashboards, the healthcare consumer is presented with a screen display that provides a concise, consolidated, and easily readable view of his or her healthcare data and is also given the ability to access numerous and widely varying external sources from the single screen display. The dashboards of the present invention enable a user to view a summary of all her healthcare data and easily obtain more detailed data on any information provided in a dashboard, regardless of the source of the information, directly from the summary as displayed and implemented by the dashboards of the user interface.

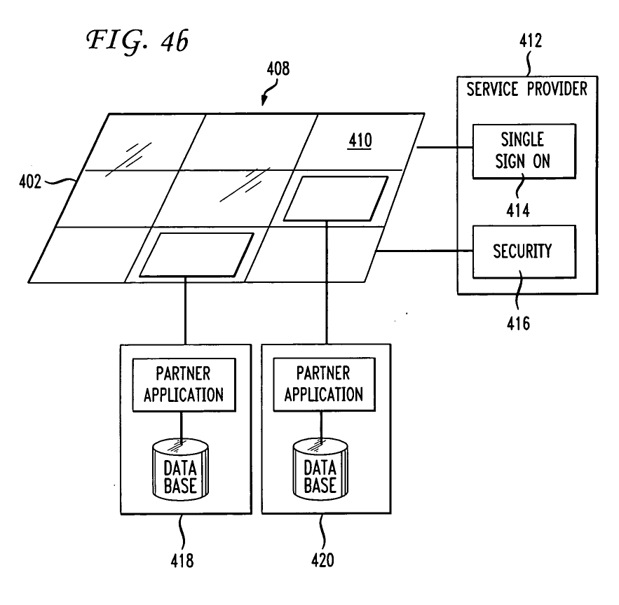

FIGS. 4a and 4b are block diagrams of software modules and network components for implementing the dashboards of the present invention. Referring first to FIG. 4a, in the described embodiment, a dashboard Web part 402 is implemented as a secure window that makes an XML request 404 for data via the Internet from an external, secure Web service 406 (e.g., a secure Web server at an insurance company) and pulls the data (not shown) back into dashboard 402. Single sign-on and patient identification mapping is performed at secure Web service 406. Referring now to FIG. 4b, dashboard 402 is a collective representation of Web parts 408 (such as individual Web part 410) that can be defined at an administrative level. These methods are known in the art and generally involve WSDL, XML, SOAP, WS-I, and implementing an additional SOA layer between the logic and the user interface in the service-oriented architecture of the healthcare data management system under control of the service provider. The SOA layer abstracts the complexity and functionality of the business logic. Also shown are a service provider 412 with single sign-on module 414 and security module 416. Partner applications 418 and 420 are secure Web services, such as service 406, that provide external data that are shown in Web parts such as Web part 410.

The user interface of the present invention integrates healthcare content for a consumer. In the described embodiment of the present invention, the consumer can correlate healthcare decisions with financial data beneficial feature to consumers given that these two data categories are closely inter-related in the modern healthcare industry. This is particularly true for healthcare consumers with chronic illnesses and who are under a consumer-directed healthcare plan. The dashboards contained in the user interface of the present invention provide a tool for organizing health-related financial data and examining the effects of a consumer's healthcare spending on her healthcare treatment and overall health. For example, using the dashboards of the present invention, a consumer can investigate whether refraining from spending money from a health savings account last month had a direct effect on certain biometric readings such as blood sugar levels, heart rate, or weight. Or whether a certain exercise regiment resulted in lower health-related out-of-pocket expenses, and so on. The present invention assists the consumer in the financial bookkeeping process that goes hand-in-hand with healthcare. I gives the consumer the tools to make better long-term health and financial decisions. This also benefits other entities in the healthcare industry, such as insurance companies and hospitals when a patient better manages her own clinical and financial risks, all parties in the healthcare industry benefit. One of the organizing principles behind the user interface and dashboards of the present invention is the ability to create value from leveraging existing relationships thereby creating an enhanced user experience that is novel and useful.

In another embodiment of the present invention, healthcare consumers can use the dashboards as a tool to strategically plan out-of-pocket expenses to prevent further healthcare costs, such as larger premiums or deductions in the future. Insurance companies are increasingly willing to reward consumers who are successful in planning their own healthcare treatment and financial strategies, for example by waiving co-pays. It is beneficial to the insurance companies to have their insured take better care of their health and spend their money as efficiently as possible and in a manner that promotes the best healthcare practices. The dashboards help consumers do this and the data provided in the dashboards can show at any given time how well a consumer/insured is doing. Based on this performance, an insurance company can reward the insured or provide incentives.

Although the foregoing invention has been described in some detail for purposes of clarity of understanding, it will be apparent that certain changes and modifications may be practiced within the scope of the appended claims. Furthermore, it should be noted that there are alternative ways of implementing both the methods and systems of the present invention. For example, professionals or healthcare providers in the industry can use the user interface and dashboards of the present invention to consolidate and integrate different types of information relevant to their practice and roles in the healthcare industry. Accordingly, the present embodiments are to be considered as illustrative and not restrictive, and the invention is not to be limited to the details given herein, but may be modified within the scope and equivalents of the appended claims.

We claim:

1. A method of providing health data and health-related data to a healthcare consumer, the method comprising:
displaying in a first plurality of dashboards, first data from internal sources;
displaying in a second plurality of dashboards, second data from external sources;
enabling access by the healthcare consumer to the second data stored at the external sources through communication over a computer network; and
authenticating the healthcare consumer once to allow healthcare consumer to view and access the first data and the second data at the external sources, wherein authentication procedures at the external sources are satisfied.

2. A computer system for providing healthcare and health-related data to a user that are displayed and viewed through a user interface, the computer system comprising:
an internal data display module having access to a personal health record of the user and able to display personal health record data in a first plurality of dashboards in the user interface;
an external data display module enabling access by the computer system to a third-party data site on a computer network such that third-party data can be displayed at a first level of detail in a second plurality of dashboards in the user interface; and
an authentication module that authenticates the user thereby enabling the user to view and edit data in the first plurality of dashboards and view at a second level of detail the third-party data at the third-party data site.

3. A user interface for displaying health-related data on a computer, the user interface comprising:
a first plurality of dashboards for displaying biometric data;
a second plurality of dashboards for displaying health-related data;
a third plurality of dashboards for displaying financial data;
wherein the first, second and third pluralities of dashboards all provide a uniform appearance of the user interface and an integrated and consolidated view of a patient's biometric data, health-related data, and financial data related to health spending; and
wherein these data are retrieved from a plurality of sources.

4. A user interface as recited in claim 3 wherein the user interface has a configuration of dashboards that facilitates financial healthcare decision-making by a patient.
